(19) United States
(12) Patent Application Publication
(10) Pub. No.: US 2017/0368524 A1
(43) Pub. Date: Dec. 28, 2017

(54) POLYMERIC MICROPARTICLES

(71) Applicant: COATEX, Genay (FR)

(72) Inventors: Clementine CHAMPAGNE, Caluire-et-Cuire (FR); Jean-Marc SUAU, Lucenay (FR)

(73) Assignee: COATEX, Genay (FR)

(21) Appl. No.: 15/533,493

(22) PCT Filed: Feb. 17, 2016
(86) PCT No.: PCT/FR2016/000025

§ 371 Date: Jun. 6, 2017

(30) Foreign Application Priority Data
Feb. 18, 2015 (FR) 1551348

(51) Int. Cl. B01J 13/08; C08F 220/18; D06M 15/263; C11B 9/00; C08L 91/06

(52) U.S. Cl. CPC B01J 13/08; C11B 9/0034; C08L 91/06; D06M 15/263; C08F 220/18; C08F 2220/1808; D06M 2200/12

(57) ABSTRACT

The present invention relates to microparticles having a polymeric shell, and also to aqueous dispersions comprising these microparticles. The microparticles having a polymeric shell comprise:
a) at least one acrylic copolymer of HASE type;
b) at least one solid/liquid phase change material having a phase transition temperature Tf₁ of greater than or equal to 20° C.;
c) at least one solid/liquid phase change material having a phase transition temperature Tf₂ of less than or equal to 30° C., provided that Tf₂ is less than Tf₁;
d) optionally at least one active agent.

### FIELD OF THE INVENTION

The present invention relates to the technical field of the encapsulation, for example of the encapsulation of active agents, by means of acrylic copolymers of HASE type.

### BACKGROUND OF THE INVENTION

Microencapsulation techniques are increasingly being developed and used in varied technical fields (for example pharmaceutical, cosmetic, textile, food processing, agrochemical, detergent or paint industry). Numerous encapsulation methods are known. Thus, it has been proposed to encapsulate active agents by in situ polymerization, by solvent extraction or also by coacervation.

Such techniques make it possible to encapsulate active agents of different chemical nature, for example hydrophilic or hydrophobic active agents, such as fragrance molecules, pharmaceutical active ingredients, cosmetic agents, photochromic or photoluminescent pigments, and the like.

The paper by Atterholt et al. (1999), for example, is concerned with the encapsulation of insect pheromones for the control of insect populations and as alternative to the use of insecticides. The document describes several encapsulation systems based on the presence of paraffin wax and/or of a soybean oil/vitamin E combination which is presented as making it possible to suppress the volatility of the pheromones.

The paper by Delmas et al. (2012) is also concerned with encapsulation using soybean oil, waxes or a mixture of the two.

Provision has also been made, in the prior art, to encapsulate active agents by means of acrylic polymers of HASE type.

In particular, the document WO 2008/146119 (Coatex) describes the use of emulsions of HASE type for trapping fragrance molecules by varying the pH of the mixture.

Also, the document WO 2014/96622 (Coatex) describes the use of an acrylic copolymer of HASE type and of at least one solid/liquid phase change material having a phase transition temperature varying from 20 to 90° C. for preparing polymeric microcapsules of an active agent, the presence of a phase change material making it possible to improve the mechanical strength of the microcapsules. Although being suited to a certain number of fields of use, the microparticles obtained according to the formulae described in the latter document have, in some other applications, the disadvantage of being excessively hard, of cracking or of lacking flexibility. This is in particular the case when the microparticles have to stay on the surfaces on which they are deposited, for example a textile or a rough surface. Furthermore, the microparticles of the prior art do not make it possible to encapsulate some active ingredients.

### BRIEF DESCRIPTION OF THE INVENTION

The present invention relates to microparticles having a polymeric shell, and also to aqueous dispersions comprising these microparticles. The microparticles having a polymeric shell comprise:
a. at least one acrylic copolymer of HASE type;
b. at least one solid/liquid phase change material having a phase transition temperature Tf₁ of greater than or equal to 20° C.;
c. at least one solid/liquid phase change material having a phase transition temperature Tf₂ of less than or equal to 30° C., provided that Tf₂ is less than Tf₁,
d. optionally at least one active agent.

The present invention also relates to the use of these microparticles or the aqueous dispersions comprising them for releasing an active agent in response to a change in pH, a change in temperature and/or to frictions and/or over time.

The present invention also relates to the use of these microparticles or the aqueous dispersions comprising them as hydrophobization agent for textiles or in the preparation of cosmetic, agrochemical, paint, textile, detergent or paper products.

The present invention also relates to a method for the preparation of an aqueous dispersion of microparticles, and also to a method for the preparation of microparticles having a polymeric shell, as are described above.

### DEFINITIONS

In the description of the present invention, the term “HASE” is an acronym for “Hydrophobically modified Alkali-Soluble Emulsions”.

In the description of the present invention, the expression “acrylic copolymer of HASE type” denotes linear or crosslinked copolymers comprising acid groups and hydrophobic groups. Copolymers of HASE type result from the copolymerization of anionic monomers, such as (meth)acrylic acids, of hydrophobic nonionic monomers and of hydrophobic associative macromonomers. At low pH (typically less than 5) and with the addition of a base, the acrylic copolymer of HASE type is insoluble in water and is present in the form of an aqueous dispersion. When a base is added, the anionic groups are neutralized and the copolymer dissolves in the water.

In the description of the present invention, the expression “solid/liquid phase change material having a phase transition temperature Tf₁ of greater than or equal to 20° C.” denotes a material which has the ability to reversibly change state at a temperature Tf₁ of greater than 20° C., for example within a temperature range varying from 20 to 90° C. This phase change material participating in the composition of the microparticles of the present invention is solid at a temperature lower than its phase transition temperature Tf₁ and liquid at a temperature greater than its phase transition temperature Tf₁. “Phase transition temperature Tf₁” denotes the melting point of the material or the temperature corresponding to the solid/liquid transition Of the phase change material.

In the description of the present invention, the expression “solid/liquid phase change material having a phase transition temperature Tf₂ of less than or equal to 30° C.” denotes a material which has the ability to reversibly change state at a temperature Tf₂ of less than 20° C. This phase change material participating in the composition of the microparticles of the present invention is solid at a temperature lower than its phase transition temperature Tf₂ and liquid at a temperature greater than its phase transition temperature Tf₂. “Phase transition temperature Tf₂” denotes the melting point of the material or the temperature corresponding to the solid/liquid transition of the phase change material.

In the present invention, the phase change materials participating in the composition of the particles of the present invention are chosen from the viewpoint of the subsequent use of the particles.

In the description of the present invention, the term “active agent” or “active ingredient” denotes any compound having an advantage in being encapsulated.

In the description of the present invention, unless otherwise indicated, the percentages expressed represent percentages by weight and are expressed based on the total weight of the reference element. For example, when it is indicated that a copolymer comprises 10% of a monomer, it is understood that the copolymer comprises 10% by weight of this monomer based on the total weight of this copolymer.

In the description of the present invention, the expression “at least one” denotes one or more compounds (for example: one or more acrylic copolymers of HASE type, one or more phase change materials, one or more active agents), such as a mixture of 2 to 5 compounds.

In the description of the present invention, the expression “microparticles” denotes particles having a mean size varying from 0.2 μm to a few tens of micrometers, such as from 0.2 to 100 μm, or from 0.5 to 70 μm, or from 1 to 40 μm. When the microparticles are spherical particles, the mean size of the particles denotes the mean diameter of the particles. When the particles are not spherical, that is to say that they have a longer dimension and a shorter dimension, the mean size of the particles denotes the size of the longest dimension of the particles. The size of the particles may be measured according to methods well known to the person skilled in the art, such as by laser granulometry.

“Microparticles having a polymeric shell” or “composite microparticles” or “microcapsules” is understood to mean microparticles having an external shell made of a copolymer according to the invention and optionally including an active agent according to the invention.

In the description of the present invention, the letters “n”, “m” and “p” denote integers or decimal numbers (in this case, they represent mean values).

In the description of the present invention, the limits of the claimed ranges are included within the scope of the invention. For example, if a group comprises between 10 and 40 carbon atoms, said group is able to comprise 10 or 40 carbon atoms.

### DETAILED DESCRIPTION OF THE INVENTION

The microparticles having a polymeric shell of the present invention are provided in the form of more or less spherical structures capable of fitting or of adhering to, at least in part, the surfaces which receive them (for example textile or external surface).

The microparticles having a polymeric shell of the present invention may be provided in the form of aqueous dispersions or they may be provided in the form of solid microparticles which are more or less soft or rigid according to the requirements of the application.

The microparticles of the present invention have the distinguishing feature of comprising at least two distinct types of solid/liquid phase change materials. More specifically, these materials differ in their solid/liquid phase transition temperature Tf. To use two types of phase change materials as essential constituents of the microcapsules according to the invention makes it possible to obtain microcapsules having different physical properties from the microcapsules of the prior art, in particular those described in the document WO 2014/96622. These microcapsules may in particular have a degree of softness which renders them more suited to a certain number of applications.

Furthermore, the base constituents of these microcapsules make it possible to obtain a more flexible and adjustable microencapsulation system which is appropriate to the requirements of expected release. In particular, by specifically choosing at least two phase change materials (for example as a function of their respective phase transition temperatures) and by fixing their respective amounts within the microcapsule composition, the temperature of release of the active ingredient is adjusted as a function of the requirements of the application.

It is also possible to more easily adjust the resistance to shearing of the microparticles.

Furthermore, the combination of the (at least) two phase change materials has the advantage of making possible better dissolution of the active ingredient, when the latter is present, within the composition, and potentially a better release.

The system described in the present patent application makes it possible to encapsulate a wide range of active ingredients and/or to increase the content of ingredients in the microparticles.

The microparticles having a polymeric shell of the present invention comprise:
a. at least one acrylic copolymer of HASE type,
b. at least one solid/liquid phase change material having a phase transition temperature Tf₁ of greater than 20° C., for example varying from 20 to 90° C.,
c. at least one solid/liquid phase change material having a phase transition temperature Tf₂ of less than or equal to 30° C., for example of less than or equal to 20° C., provided that Tf₂ is less than Tf₁, and
d. optionally at least one active agent.

Acrylic Copolymer of HASE Type:

The acrylic copolymers of HASE type form the external shell of the microparticles of the present invention.

According to embodiments of the invention, the acrylic copolymers of HASE type participating in the composition of the microparticles of the present invention comprise the following monomers:
i. at least one anionic monomer having a polymerizable vinyl group and a carboxyl group;
ii. at least one nonionic hydrophobic monomer having a polymerizable vinyl group; and
iii. at least one alkoxylated associative macromonomer having a polymerizable vinyl group and a hydrophobic hydrocarbon chain.

The anionic monomers i. having a polymerizable vinyl group and a carboxyl group are monomers having a negative charge in basic aqueous solution. The anionic monomers having a polymerizable vinyl group and a carboxyl group are, for example, chosen from acrylic acid and/or methacrylic acid.

The nonionic hydrophobic monomers ii. having a polymerizable vinyl group are monomers having neither a positive charge nor a negative charge in aqueous solution. The nonionic hydrophobic monomers having a polymerizable vinyl group are, for example, chosen from esters, amides or nitriles of acrylic or methacrylic acids or from acrylonitrile, vinyl acetate, styrene, methylstyrene, diisobutylene, vinylpyrrolidone or vinylcaprolactam. Very particularly, the nonionic hydrophobic monomers having a polymerizable vinyl group may be chosen from C₁-C₈ alkyl acrylates or C₁-C₈ alkyl methacrylates, such as methyl acrylate, ethyl acrylate, butyl acrylate, 2-ethylhexyl acrylate, methyl methacrylate, ethyl methacrylate, butyl methacrylate or their mixtures. More particularly, the nonionic hydrophobic monomers having a polymerizable vinyl group may be chosen from ethyl acrylate, butyl acrylate, ethyl methacrylate or their mixtures.

The alkoxylated associative macromonomer iii. having a polymerizable vinyl group and a hydrophobic hydrocarbon chain may have the following formula (I):

R-A-R′ (I)

in which:
A represents a polymer chain consisting of:
   m alkylene oxide units of formula —CH₂CHR₁O— with R₁ representing an alkyl group comprising from 1 to 4 carbons, for example a methyl or ethyl group, and m varying from 0 to 150,
   p alkylene oxide units of formula —CH₂CHR₂O— with R₂ representing an alkyl group comprising from 1 to 4 carbons, for example a methyl or ethyl group, and p varying from 0 to 150,
   n ethylene oxide units with n varying from 0 to 150, or from 10, or 15, to 150, or from 10, or 15, to 100, or from 15 to 50, or from 15 to 30,

in which m+n+p>4, or m+n+p>5, and in which the alkylene oxide units of formula —CH₂CHR₁O—, the alkylene oxide units of formula —CH₂CHR₂O— and the ethylene oxide units are in blocks, alternating or random;
R represents a radical containing a polymerizable unsaturated group belonging to the group of acrylic, methacrylic, maleic, itaconic or crotonic esters; and
R′ represents a straight or branched hydrocarbon chain comprising from 6 to 40 carbon atoms or from 7 to 35 carbon atoms or from 8 to 22 carbon atoms or from 10 to 20 carbon atoms (limits included) or a substituted or unsubstituted cycloalkyl or aryl group comprising from 6 to 100 carbon atoms or from 6 to 60 carbon atoms.

The R₁ and R₂ groups may be identical or different.

In specific embodiments, the alkoxylated associative macromonomer having a polymerizable vinyl group and a hydrophobic hydrocarbon chain has the following formula (I):

R-A-R′ (I)

in which R, R′ and A are as defined above, with n representing a number of ethylene oxide units varying from 15 to 150 or from 15 to 50 or from 15 to 30.

In specific embodiments, the alkoxylated associative macromonomer having a polymerizable vinyl group and a hydrophobic hydrocarbon chain has the following formula (I):

R-A-R′ (I)

in which R represents a radical containing a polymerizable unsaturated group belonging to the group of the acrylic and methacrylic esters and A and R′ are as defined in the embodiments described above.

In specific embodiments, the alkoxylated associative macromonomer having a polymerizable vinyl group and a hydrophobic hydrocarbon chain has the following formula (I):

R-A-R′ (I)

in which R′ represents a straight or branched hydrocarbon chain comprising from 8 to 20 carbon atoms or from 8 to 16 carbon atoms, preferably a straight hydrocarbon chain of 8 to 22 carbon atoms (for example, C₈, C₁₂, C₁₆₋₁₈, C₂₂), or a branched chain of 12 to 20 carbon atoms (for example, C₁₂, C₁₆, C₂₀) and A and R are as defined in the embodiments described above.

In specific embodiments, the alkoxylated associative macromonomer having a polymerizable vinyl group and a hydrophobic hydrocarbon chain has the following formula (I):

R-A-R′ (I)

in which A, R and R′ are as defined in the embodiments described above, with m and p respectively representing 0.

In specific embodiments, the alkoxylated associative macromonomer having a polymerizable vinyl group and a hydrophobic hydrocarbon chain has the following formula (I):

R-A-R′ (I)

in which:
A is as defined in the embodiments described above, with m and p respectively representing 0 and n varying from 15 to 150 or from 15 to 50 or from 15 to 30 (thus A represents a polymeric chain formed of 15 to 150 or of 15 to 50 or of 15 to 30 ethylene oxide units);
R represents a radical containing a polymerizable unsaturated group belonging to the group of the acrylic, methacrylic, maleic, itaconic or crotonic esters, preferably belonging to the group of the acrylic and methacrylic esters; and
R′ represents a straight or branched hydrocarbon chain comprising from 6 to 40 carbon atoms, or from 7 to 35 carbon atoms or from 8 to 22 carbon atoms.

In specific embodiments, the alkoxylated associative macromonomer having a polymerizable vinyl group and having a hydrophobic hydrocarbon chain has the following formula (I):

R-A-R′ (I)

in which:
A is as defined in the embodiments described above, with m and p respectively representing 0 and n varying from 15 to 150 or from 15 to 50 or from 15 to 30 (thus A represents a polymeric chain formed of 15 to 150 or of 15 to 50 or of 15 to 30 ethylene oxide units);
R represents a radical containing a polymerizable unsaturated group belonging to the group of the acrylic and methacrylic esters; and

R′ represents a straight or branched hydrocarbon chain comprising from 8 to 22 carbon atoms, for example a straight hydrocarbon chain of 8 to 22 carbon atoms (for example, C₈, C₁₂, C₁₆₋₁₈, C₂₂), or a branched chain of 12 to 20 carbon atoms (for example, C₁₂, C₁₆, C₂₀).

In specific embodiments, the acrylic copolymers participating in the composition of the particles of the present invention comprise:
i. at least one anionic monomer having a polymerizable vinyl group and a carboxyl group chosen from acrylic acid, methacrylic acid or their mixture;
ii. at least one nonionic hydrophobic monomer having a polymerizable vinyl group chosen from ethyl acrylate, methyl methacrylate, butyl acrylate or their mixtures; and
iii. at least one alkoxylated associative macromonomer having a polymerizable vinyl group and having a hydrocarbon chain of following formula (I):

R-A-R′ (I)

in which A, R and R′ are as defined in the embodiments described above.

In specific embodiments, the acrylic copolymers participating in the composition of the particles of the present invention comprise:
i. at least one anionic monomer having a polymerizable vinyl group and a carboxyl group chosen from acrylic acid, methacrylic acid or their mixture;
ii. at least one nonionic hydrophobic monomer having a polymerizable vinyl group chosen from ethyl acrylate, methyl methacrylate, butyl acrylate or their mixtures;
iii. at least one alkoxylated associative macromonomer having a polymerizable vinyl group and having a hydrophobic hydrocarbon chain of formula (I):

R-A-R′ (I)

in which:
A is as defined in the embodiments described above, with m and p respectively representing 0 and n varying from 15 to 150 or from 15 to 50 or from 15 to 30 (thus A represents a polymeric chain formed of 15 to 150 or of 15 to 50 or of 15 to 30 ethylene oxide units);
R represents a radical containing a polymerizable unsaturated group belonging to the group of acrylic, methacrylic, maleic, itaconic, methacrylurethane, vinylurethane or crotonic esters, preferably to the group of the acrylic and methacrylic esters;
R′ represents a straight or branched hydrocarbon chain comprising from 8 to 22 carbon atoms, for example a straight hydrocarbon chain of 8 to 22 carbon atoms (for example, C₈, C₁₂, C₁₆₋₁₈, C₂₂), or a branched chain of 12 to 20 carbon atoms (for example, C₁₂, C₁₆, C₂₀).

The acrylic copolymers participating in the composition of the particles of the present invention typically comprise:
i. from 20% to 65% or from 30% to 45% by weight of at least one anionic monomer having a polymerizable vinyl group and a carboxyl group;
ii. from 35% to 75% or from 45% to 60% by weight of at least one nonionic hydrophobic monomer having a polymerizable vinyl group; and
iii. from 0.5% to 15% or from 1% to 13% by weight of at least one alkoxylated associative macromonomer having a polymerizable vinyl group and a hydrophobic hydrocarbon chain, more particularly of an alkoxylated associative macromonomer of following formula (I):

R-A-R′ (I)

in which A, R and R′ are as defined in the embodiments described above.

In specific embodiments, the acrylic copolymers participating in the composition of the particles of the present invention comprise:
i. from 20% to 65% or from 30% to 45% by weight of at least one anionic monomer having a polymerizable vinyl group and a carboxyl group chosen from acrylic acid, methacrylic acid or their mixture;
ii. from 35% to 75% or from 45% to 60% by weight of at least one nonionic hydrophobic monomer having a polymerizable vinyl group chosen from ethyl acrylate, methyl methacrylate, butyl acrylate or their mixtures; and
iii. from 0.5% to 15% or from 1% to 13% by weight of at least one alkoxylated associative macromonomer having a polymerizable vinyl group and having a hydrophobic hydrocarbon chain of formula (I):

R-A-R′ (I)

in which:
A is as defined in the embodiments described above, with m and p respectively representing 0 and n varying from 15 to 150 or from 15 to 50 or from 15 to 30 (thus A represents a polymeric chain formed of 15 to 150 or of 15 to 50 or of 15 to 30 ethylene oxide units);
R represents a radical containing a polymerizable unsaturated group belonging to the group of the acrylic, methacrylic, maleic, itaconic, methacrylurethane, vinylurethane or crotonic esters, preferably to the group of the acrylic and methacrylic esters; and
R′ a straight or branched hydrocarbon chain comprising from 8 to 22 carbon atoms, for example a straight hydrocarbon chain of 8 to 22 carbon atoms (for example, C₈, C₁₂, C₁₆₋₁₈, C₂₂), or a branched chain of 12 to 20 carbon atoms (for example, C₁₂, C₁₆, C₂₀).

The acrylic copolymers of HASE type participating in the composition of the particles of the present invention result from the copolymerization of the monomers described above. They may be prepared according to the methods described in the documents WO 2011/104599, WO 2011/104600 and EP 1,778,797.

During the polymerization, a chain transfer agent may be added in order to control the molecular weight of the copolymer. The chain transfer agent may be chosen from the mercaptans, such as ethyl mercaptan, n-propyl mercaptan, n-butyl mercaptan, isobutyl mercaptan, t-butyl mercaptan, n-amyl mercaptan, isoamyl mercaptan, t-amyl mercaptan, n-hexyl mercaptan, cyclohexyl mercaptan, n-octyl mercaptan, n-decyl mercaptan or n-dodecyl mercaptan.

Phase Change Material Having a Phase Transition Temperature Tf₁

The particles of the present invention comprise at least one solid/liquid phase change material having a phase transition temperature Tf₁ of greater than or equal to 20° C. For example, this phase change material has the ability to reversibly change state within a range of temperatures varying from 20 to 90° C. or from 25 to 80° C. or from 35 to 70° C.

The phase change materials participating in the composition of the particles of the present invention may be chosen from waxes of natural or synthetic origin. The waxes of natural origin include animal waxes, vegetable waxes and mineral waxes.

Animal and vegetable waxes are generally formed of a mixture of lipids having a long hydrocarbon chain, such as fatty acids, fatty alcohols or esters of fatty acid or of fatty alcohol, indeed even ethers. “Long hydrocarbon chains” is understood to mean hydrocarbon chains having, for example, from 10 to 40 carbon atoms. Animal and vegetable waxes typically have a phase transition temperature varying from 25° C. to 90° C. Examples of vegetable waxes include carnauba, candelilla, sugarcane or esparto wax or shea butter. Examples of animal waxes include beeswaxes or lanolin.

Mineral waxes, including paraffin waxes, are generally formed of saturated hydrocarbons having a straight chain comprising, for example, from 20 to 40 carbon atoms. Mineral waxes typically have a phase transition temperature ranging from 25° C. to 90° C. Examples of mineral wax include ceresin, ozokerite, paraffin waxes and microcrystalline waxes. Examples of paraffin waxes include heneicosane, the melting point of which is 40.5° C., eicosane, the melting point of which is 36.1° C., and nonadecane, the melting point of which is 32.1° C.

Waxes of synthetic origin are generally formed of long hydrocarbon chains devoid of functional groups. Examples of waxes of synthetic origin include polymers based on polyethylene and polymers based on polyalkylene glycol, such as polymers based on polyethylene glycol and polymers based on polypropylene glycol.

Mention is also made of silicone-based or organosilylated waxes of synthetic origin.

The phase change materials participating in the composition of the microparticles of the present invention may be chosen from alcohols comprising a long hydrocarbon chain, for example alcohols having from 14 to 30 carbon atoms or from 14 to 22 carbon atoms, such as myristyl alcohol, cetyl alcohol, stearyl alcohol, arachidyl alcohol or behenyl alcohol, fatty acids comprising a long hydrocarbon chain, for example the acids having from 12 to 30 carbon atoms or from 12 to 22 carbon atoms, such as decanoic acid, lauric acid, myristic acid, palmitic acid, stearic acid, arachidic acid or behenic acid, fatty acid esters, such as decanoic acid, lauric acid, myristic acid, palmitic acid, stearic acid, arachidic acid or behenic acid esters, fatty ethers or their mixtures.

Phase Change Material Having a Phase Transition Temperature Tf₂

The particles of the present invention comprise at least one plasticizing material. According to one embodiment, this solid/liquid phase change material has a phase transition temperature Tf₂ of less than or equal to 30° C., provided that this phase transition temperature Tf₂ is less than the phase transition temperature Tf₁ of the other phase change material present in the microparticles of the invention. For example, this phase change material has the ability to reversibly change state at a temperature of less than or equal to 25° C., for example ≦20° C., or 18° C. or 15° C.

The phase change materials participating in the composition of the particles of the present invention may be chosen from polar oils, nonpolar oils or their mixtures.

In the “nonpolar oil” category, mention is made in particular of silicone oils, such as linear or cyclic polydimethylsiloxanes (PDMSs) which are liquid at ambient temperature; polydimethylsiloxanes comprising alkyl, alkoxy or phenyl groups which are liquid at ambient temperature, which groups are pendant and/or are at the end of the silicone chain and have from 2 to 24 carbon atoms; liquid phenylated silicones, such as phenyl trimethicones, phenyl dimethicones, phenyl(trimethylsiloxy)diphenylsiloxanes, diphenyl dimethicones, diphenyl(methyldiphenyl)trisiloxanes or (2-phenylethyl)trimethylsiloxysilicates; liquid linear or branched hydrocarbons or fluorocarbons of synthetic or mineral origin, such as paraffin oils and their derivatives, vaseline, polydecenes, hydrogenated polyisobutene or squalane; and their mixtures.

In the “polar oil” category, mention is made in particular of vegetable oils, synthetic oils, synthetic esters and ethers, fatty alcohols, fatty acids and their mixtures.

Examples of these oils are in particular:
hydrocarbon vegetable oils having a high content of triglycerides formed of esters of fatty acids (C₈ to C₂₄ fatty acids) and of glycerol, the fatty acids of which may have varied chain lengths, it being possible for the chains to be straight or branched and saturated or unsaturated; these oils are in particular wheat germ oil, corn oil, sunflower oil, shea oil, castor oil, sweet almond oil, linseed oil, macadamia oil, apricot oil, soybean oil, rapeseed oil, cottonseed oil, alfalfa oil, poppy oil, red kuri squash oil, sesame oil, pumpkin oil, avocado oil, hazelnut oil, grape seed oil, blackcurrant oil, evening primrose oil, millet oil, barley oil, quinoa oil, olive oil, rye oil, safflower oil, candlenut oil, passiflora oil or musk rose oil;
synthetic oils of formula R₅COOR₆ in which R₅ represents the residue of a straight or branched higher fatty acid comprising from 7 to 40 carbon atoms and R₆ represents a branched hydrocarbon chain containing from 3 to 40 carbon atoms, such as, for example, purcellin oil (cetearyl octanoate), isononyl isononanoate or C₁₂ to C₁₅ alcohol benzoate;
synthetic esters and ethers, such as isopropyl myristate, 2-ethylhexyl palmitate, octanoates, decanoates or ricinoleates of alcohols or polyalcohols, hydroxylated esters, such as isostearyl lactate or diisostearyl malate, and pentaerythritol esters;
C₈ to C₂₆ fatty alcohols, such as oleic alcohol;
fatty acids having from 12 to 22 carbon atoms, such as oleic acid, linoleic acid or linolenic acid;
citric acid and its derivatives (for example, ethyl citrate);
adipic acid and its derivatives (for example, diisobutyl adipate);
their mixtures.

Active Agent

The microparticies of the present nvention comprise at least one active agent.

The active agent may be chosen from the group consisting of fragrances, fragrance molecules, flavorings, opacifying agents, hydrating agents, softening agents, refreshing agents, dyes, plasticizers, slimming agents, pharmaceutical active ingredients, inks, pigments, agrochemical active ingredients, herbicides, antiseptics, detergents, enzymes, antifoarning agents, bleaching agents, optical brighteners, biocides, UV stabilizers, antioxidants corrosion inhibitors, fungicides and antibacterial agents.

Mention is made, by way of indication of fragrances and fragrance molecules, of terpene derivatives, such as limonene, citronellal, terpineol and menthol.

In some embodiments of the present invention, the active agent is a fragrance or a fragrance molecule.

According to one embodiment of the present invention, the active agent is neither a pheromone nor a semiochemical agent.

The Microparticles of the Present Invention

In some embodiments, the microparticles of the present invention comprise, based on the total weight of the microparticles:
from 1 to 20% or from 1 to 15% or from 1 to 10% by weight of at least one acrylic copolymer of HASE type as described above;
from 4 to 95% or from 4 to 75% or from 4 to 50% by weight of at least one solid/liquid phase change material having a phase transition temperature Tf₁ of greater than or equal to 20° C., as described above;
from 4 to 95% by weight of at least one solid/liquid phase change material having a phase transition temperature Tf₂ of less than or equal to 30° C., provided that Tf₂ is less than Tf₁, as described above, and
from 4 to 95% or from 24 to 95% or from 49 to 95% by weight of at least one active agent as described above.

In another embodiment of the present invention, the weight ratio of the solid/liquid phase change material having a phase transition temperature Tf₁ of greater than or equal to 20° C. to the solid/liquid phase change material having a phase transition temperature Tf₂ of less than or equal to 30° C. is between 1/10 and 10/1.

The microparticles of the present invention may be provided in the form of an aqueous dispersion of particles or they may be provided in the solid form, that is to say in the form of solid granules (or microcapsules). Thus, the present invention relates to aqueous dispersions comprising microparticles as described above and solid microparticles with a composition as described above.

The aqueous dispersions of microparticles may comprise from 1 to 70% by weight of microparticles.

The microparticles of the present invention have a composition such that they release the contents of the polymeric shell in response to a change in pH, a change in temperature and/or under the action of a friction and/or under the action of time.

If these microparticles do not contain an active agent, because they are, for example, intended for rendering textiles hydrophobic, the shearing (or friction) of these microparticles results in the destructuring of the particles. The latter then release their contents at the surface of the textile to be treated. The contents of the microcapsules are in this case chosen so as to be, for example, predominantly made of solid/liquid phase change materials of a fatty nature (mixture of wax/oil type).

The microcapsules may alternatively contain at least one active agent. In this case, the microparticles of the present invention are such that they make it possible to release the encapsulated active agent in response to a change in pH, a change in temperature and/or a shearing/a friction.

The microparticles of the present invention thus have a minimum mechanical strength, such that they maintain their integrity after having been prepared. It is also possible to adjust the composition of the microparticles in order to increase the resistance to shearing. Thus, according to this aspect, the microparticles of the present invention are “controlled mechanical strength” microparticles.

The concentrations of acrylic copolymer of HASE type, of phase change materials and/or of active agent may be adjusted in order to obtain microparticles which are soft/rigid to a greater or lesser extent or in order to adjust their resistance to shearing actions.

More particularly, the amount of solid/liquid phase change material having a phase transition temperature Tf₂ of less than or equal to 30° C. is chosen so that the microcapsules which contain them have a mechanical strength which may be greater or lower as a function of the release effect desired (rapid or very delayed).

The dispersions or microparticles of the present invention may be used in the field of cosmetology, for example to formulate lotions, shampoos, creams, deodorants, makeup compositions or care compositions. Mention is made in this regard in particular of encapsulation of fragrances, essential oils, opacifiers, hydrating agents, softening agents, refreshing agents or slimming agents.

The dispersions or microparticles of the present invention may be used in the field of the textile industry, for example in the manufacture of clothes, pantyhoses, bottoms or gloves. Mention may be made in this regard in particular of the encapsulation of fragrances, slimming agents, antiperspirants or antibacterial agents. The dispersions or microparticles are then applied to various textiles.

The dispersions or microparticles of the present invention may be used in the field of paints or dyes: pigments or resins may in particular be encapsulated.

The microparticles of the present invention may be used in the field of the paper industry (encapsulation of inks or of fragrance molecules) or of the manufacture of detergents (encapsulation of fragrance, antifoaming or whitening agents).

Thus, the solid microparticles or aqueous dispersions of microparticles of the present invention may be used in the preparation of cosmetic, agrochemical, detergent, paint, textile or paper products.

Methods for the Preparation of the Dispersion of Microparticles and of the Microparticles

An object of the present invention also relates to a method for the preparation of an aqueous dispersion of microparticles and to a method for the preparation of microparticles having a polymeric shell, as described above. The solid microparticles of the present invention are generally produced from an aqueous dispersion of microparticles.

The aqueous dispersions of microparticles may be prepared by a method comprising the following steps:

a) preparation of an aqueous solution comprising:
at least one acrylic copolymer of HASE type dissolved in said aqueous solution by means of a base;
at least one solid/liquid phase change material having a phase transition temperature Tf₁ of greater than or equal to 20° C., said solid/liquid phase change material being present in or having been introduced into the aqueous solution at a temperature greater than its phase transition temperature Tf₁,
at least one solid/liquid phase change material having a phase transition temperature Tf₂ of less than or equal to 30° C., for example less than or equal to 20° C.; and
optionally at least one active agent; and

b) coacervation of the acrylic polymer of HASE type in order to result in said aqueous dispersions of microparticles.

When the solid/liquid phase change material is said to be “present in the aqueous solution at a temperature greater than its phase transition temperature Tf₁”, it is understood that all of the constituents in the aqueous solution are at a temperature greater than the phase transition temperature of the phase change material.

When the solid/liquid phase change material is described as “having been introduced into the aqueous solution at a temperature greater than its phase transition temperature Tf₁”, it is understood that the material has been added at a temperature greater than its phase transition temperature Tf₁ but that the water, the base, the copolymer of HASE type and the active agent may be at a temperature of lower than this phase transition temperature Tf₁. The final aqueous solution comprising the acrylic copolymer of HASE type, the base, the active agent and the two phase change materials thus generally has a temperature of lower than the phase transition temperature Tf₁.

In general, the solid/liquid phase change material having a phase transition temperature Tf₁ of greater than or equal to 20° C., alone or as a mixture with the active agent and the second phase change material (having a phase transition temperature Tf₂ of less than or equal to 30° C.), is heated to a temperature greater than its phase transition temperature Tf₁ and introduced at a temperature greater than its phase transition temperature Tf₁ into an aqueous solution comprising the other constituents of the microcapsules, this aqueous solution generally having a temperature lower than the phase transition temperature Tf₁ of the phase change material.

In step a), the base is added in an amount which makes it possible to dissolve the acrylic copolymer of HASE type in the aqueous solution.

The base employed in the method is typically an organic or inorganic base. The base may, for example, be chosen from sodium hydroxide, ammonia, potassium hydroxide and 2-amino-2-methyl-1-propanol.

The papers by Jenkins et al., 2002 (J. Phys. Chem. B, 2002, 106, 1195-1204) and Horiuchi et al., 1998 (Can. J. Chem., 76, 1779-1787) describe the phenomenon of dissolution of HASE polymers during the addition of a base.

According to embodiments of the invention, the amount of base used to dissolve the copolymer is such that the pH of the aqueous solution is greater than or equal to 6.5, or greater than or equal to 7, or greater than or equal to 7.5.

According to other embodiments of the invention, as a function of the type of base used, in particular if the base used is sodium hydroxide, the amount of base used to dissolve the copolymer is such that the molar ratio (nOH⁻/nCOOH) of the number of hydroxyl groups contributed by the base (nOH⁻) to the number of carboxyl groups carried by the acrylic copolymer of HASE type (nCOOH) is greater than 0.3, or greater than 0.4, or greater than 0.45 and preferably less than 1.2. The number of carboxyl groups carried by the acrylic copolymer of HASE type may be determined by methods known to the person skilled in the art, such as by titration.

According to embodiments of the invention, the aqueous solution of step a) is prepared with stirring.

The step of coacervation of the acrylic polymer of HASE type resulting in the aqueous dispersions of microparticles (step b)) is carried out once the aqueous solution is at a temperature lower than the phase transition temperature of the phase change material Tf₁, that is to say after cooling of the aqueous solution.

The coacervation may be carried out by addition of salts, such as sodium chlorides, or alternatively by addition of an acid.

In some embodiments of step b) of the method, the coacervation is carried out by addition of an acid. The acid employed in the method may in particular be chosen from an organic or inorganic acid. More particularly, the acid may be chosen from phosphoric acid, hydrochloric acid, acetic acid, citric acid, D-gluconic acid, glutamic acid and ascorbic acid.

In some embodiments of step b) of the method, the amount of acid used to carry out the coacervation is such that the pH of the dispersion is less than or equal to 6.5 or less than or equal to 6.3.

In other embodiments of step b) of the method, as a function of the type of acid used, in particular if the acid used is acetic acid, the amount of acid added is such that the molar ratio (nH₃O⁺/nCOOH) of the number of protons contributed by the acid (nH₃O⁺) to the number of carboxyl groups carried by the acrylic copolymer of HASE type (nCOOH) is greater than 0.1, or greater than 0.15, or greater than 0.2 and less than 1.

According to embodiments of the invention, the addition of salt or of acid is carried out with stirring.

The coacervation (or precipitation) of the acrylic polymer of HASE type makes it possible to form a polymeric shell which constitutes the external shell of the microparticles.

In some embodiments, the aqueous solution comprising the dissolved acrylic copolymer of HASE type, the active agent and the solid/liquid phase change material (step a)) is prepared according to the following steps:
a1) preparation of an aqueous solution comprising the acrylic copolymer of HASE type dissolved by means of a base;
a2) preparation of a mixture comprising the active agent and the phase change material, said mixture being prepared at a temperature greater than the phase transition temperature of the phase change material or being subsequently heated to a temperature greater than the phase transition temperature of the phase change material; and
a3) introduction of the mixture, for example with stirring, obtained in step a2) into the aqueous solution obtained in step a1).

It is noted that, according to these embodiments, during step a3):
the mixture obtained in step a2) is at a temperature greater than the phase transition temperature of the phase change material, for example at a temperature between the phase transition temperature of the phase change material and the heating temperature of the mixture a2);
the aqueous solution obtained in step a1) is at a temperature lower than the phase transition temperature of the phase change material.

According to embodiments of the invention, the introduction of the mixture obtained in step a2) into the aqueous solution obtained in step a1) is carried out with stirring.

In other embodiments, the aqueous solution comprising the dissolved acrylic copolymer of HASE type, the active agent and the solid/liquid phase change material (step a)) may be prepared according to the following steps:
a1) preparation of an aqueous solution comprising the acrylic copolymer of HASE type dissolved by means of a base, at least one active agent and at least one phase change material; and
a2) heating the aqueous solution obtained in step a1) to a temperature greater than the transition temperature of the phase change material.

According to embodiments of the invention, the aqueous solution is prepared (step a1)) with stirring or it is stirred after having been prepared. In this case, it may be stirred before, during or after heating (step a2)), but before carrying out step b).

According to these embodiments, the order of introduction of the acrylic copolymer of HASE type, of the base, of the active agent and of the phase change material in order to result in the aqueous solution of step a1) is not important.

Thus, the acrylic copolymer of HASE type, the water and the base may be mixed together in a first stage. A second mixture comprising the phase change material and the active agent may be added to this mixture, so as to obtain the aqueous solution of step a1).

Alternatively, the acrylic copolymer of HASE type, the water, the base, the phase change material and the active agent may be mixed together, without a preliminary step of submixing, to give the aqueous solution of step a1).

Thus, according to the present invention, the aqueous dispersions of particles may be prepared by a method comprising the following steps:
a1) preparation of an aqueous solution comprising a base and at least one acrylic copolymer of HASE type, more particularly an acrylic copolymer of HASE type as described above;
a2) preparation of a mixture comprising at least one active agent and at least the two phase change materials, said mixture being prepared at a temperature greater than the phase transition temperature Tf₁ of the phase change material (the phase transition temperature Tf₁ of which is greater than or equal to 20° C.);
a3) introduction of the mixture obtained in step a2) into the aqueous solution obtained in step a1); and
b) coacervation of the acrylic copolymer of HASE type in order to result in the aqueous dispersions of particles.

Alternatively, the aqueous dispersions of particles of the present invention may be prepared by a method comprising the following steps:
a1) preparation of an aqueous solution comprising a base, at least one active agent, at least the two phase change materials and at least one acrylic copolymer of HASE type, more particularly an acrylic copolymer of HASE type as described above;
a2) heating the aqueous solution obtained in step a1) to a temperature greater than the temperature Tf₁ of the phase change material (the phase transition temperature Tf₁ of which is greater than or equal to 20° C.); and
b) coacervation of the acrylic copolymer of HAST type in order to result in the aqueous dispersions of particles.

Solid microparticles may be obtained after drying the dispersions of microparticles obtained in step b).

The acrylic copolymer of HASE type, the phase change materials and the active agent employed in the methods of the present invention may be as described in the description of the present invention.

The methods used in the preparation of the microparticles of the present invention are environmentally friendly since no use is made of organic solvent.

Use of the Dispersion or of the Microparticles

An object of the present invention also relates to the use of microparticles according to the invention or of aqueous dispersions of microparticles according to the invention in the preparation of cosmetic, agrochemical, paint, textiles, detergent or paper products.

Another object of the present invention relates to the use of microparticles according to the invention or of aqueous dispersions of microparticles according to the invention for rendering textiles hydrophobic.

Yet another object of the present invention relates to the use of microparticles according to the invention or of aqueous dispersions of microparticles according to the invention for releasing an active agent in response to a change in pH, a change in temperature and/or to frictions and/or over time.

The present invention also relates to a hydrophobization agent for textiles consisting of microparticles according to the invention or of aqueous dispersions of microparticles according to the invention.

### EXAMPLES

### Example 1

This example illustrates the preparation of a dispersion of microparticles according to the invention without an active principle.

### Preparation of the HASE Acrylic Copolymer

The acrylic copolymer according to the invention is prepared according to methods known to the person skilled in the art by means of a chain transfer agent of mercaptan type.

This copolymer is made of:

35.5% by weight of methacrylic acid,

52.4% by weight of ethyl acrylate,

12.0% by weight of a macromonomer of formula (I) in which:
m and p=0,
n=30,
R represents a methacrylic ester,
R′ represents a branched hydrocarbon chain comprising 12 carbon atoms.

### Test 1-1: Preparation of a Dispersion of Microparticles According to the Present Invention

Preparation of an Aqueous Solution

7.5 g of the HASE copolymer (polymerized at 30.8% in water) are dissolved in 59.25 g of water in the presence of 3.8 g of 10% sodium hydroxide solution by stirring in a mechanical stirrer at a temperature of 40° C.

15.75 g of paraffin wax sold by Sigma-Aldrich under the reference Paraffin Wax 327204 (Tf₁=53-57° C.) are mixed with 47.25 g of commercial sunflower oil (Tf₂<0° C.). The mixture is stirred and heated to a temperature of approximately 90° C. The liquid paraffin wax/sunflower oil mixture (at a temperature of between Tf₁ and 80° C.) is introduced into the aqueous solution of HASE copolymer using a peristaltic pump.

Coacervation

6.44 g of a 4% H₃PO₄ solution are added to the aqueous solution of HASE copolymer to which the paraffin wax/sunflower oil mixture has been added. A dispersion which is white in color with a pH of 6.2, the D50% diameter of the particles of which is 5.3 μm.

### Test 1-2: Preparation of a Dispersion of Microparticles Outside the Invention

Preparation of an Aqueous Solution

15 g of the HASE copolymer (polymerized at 30.8% in water) are dissolved in 118 g of water in the presence of 7.62 g of 10% sodium hydroxide solution by stirring in a mechanical stirrer at a temperature of 40° C.

126 g of paraffin wax sold by Sigma-Aldrich under the reference Paraffin Wax 327204 (Tf₁=53-57° C.) are stirred and heated to a temperature of approximately 90° C.

The liquid paraffin wax (at a temperature of between Tf₁ and 80° C.) is introduced into the aqueous solution of HASE copolymer using a peristaltic pump.

Coacervation

12.88 g of a 4% H₃PO₄ solution are added to the aqueous solution of HASE copolymer to which the paraffin wax has been added. Under these conditions, lumps are obtained; it is not possible to obtain a dispersion of microparticles as in test 1-1.

### Example 2

This example illustrates the preparation of two dispersions of microparticles according to the invention without an active ingredient.

### Preparation of the HASE Acrylic Copolymer

The acrylic copolymer according to the invention is prepared according to methods known to the person skilled in the art by means of a chain transfer agent of mercaptan type.

This copolymer is made of:

35.5% by weight of methacrylic acid,

52.4% by weight of ethyl acrylate,

12.0% by weight of a macromonomer of formula (I) in which:
m and p=0,
n=30,
R represents a methacrylic ester,
R′ represents a branched hydrocarbon chain comprising 12 carbon atoms.

### Test 2-1: Preparation of a Dispersion of Microparticles According to the Present Invention

Preparation of an Aqueous Solution

7.5 g of the HASE copolymer (polymerized at 30.8% in water) are dissolved in 59.25 g of water in the presence of 3.8 g of 10% sodium hydroxide solution by stirring in a mechanical stirrer at a temperature of 40° C.

15.75 g of beeswax sold by Sigma-Aldrich (Tf₁=61-65° C.) are mixed with 47.25 g of commercial sunflower oil. The mixture is stirred and heated to a temperature of approximately 80° C.

This liquid ternary mixture (at a temperature of between Tf₁ and 80° C.) is introduced into the aqueous solution of HASE copolymer using a peristaltic pump.

Coacervation

6.44 g of a 4% H₃PO₄ solution are added to the aqueous solution of HASE copolymer to which the liquid ternary mixture has been added. A dispersion which is white in color is obtained.

### Test 2-2: Preparation of a Dispersion of Microparticles According to the Present Invention

Preparation of an Aqueous Solution

7.5 g of the HASE copolymer (polymerized at 30.8% in water) are dissolved in 59.25 g of water in the presence of 3.8 g of 10% sodium hydroxide solution by stirring in a mechanical stirrer at a temperature of 40° C.

15.75 g of siliconyl beeswax sold by Koster Keunen (Tf₁=75° C.) are mixed with 47.25 g of silicon oil sold by VWR (Tf₂<0° C.). The mixture is stirred and heated to a temperature of approximately 90° C.

This liquid ternary mixture (at a temperature of between Tf₁ and 80° C.) is introduced into the aqueous solution of HASE copolymer using a peristaltic pump.

Coacervation

6.44 g of a 4% H₃PO₄ solution are added to the aqueous solution of HASE copolymer to which the liquid ternary mixture has been added. A dispersion which is white in color is obtained.

### Example 3

This example illustrates the preparation of two dispersions of microparticles according to the invention with terpineol as active ingredient.

### Preparation of the HASE Acrylic Copolymer

The acrylic copolymer according to the invention is prepared according to methods known to the person skilled in the art by means of a chain transfer agent of mercaptan type.

This copolymer is made of:

35.5% by weight of methacrylic acid,

52.4% by weight of ethyl acrylate,

12.0% by weight of a macromonomer of formula (I) in which:
m and p=0,
n=30,
R represents a methacrylic ester,
R′ represents a branched hydrocarbon chain comprising 12 carbon atoms.

### Test 3-1: Preparation of a Dispersion of Microparticles According to the Present Invention

Preparation of an Aqueous Solution

7.5 g of the HASE copolymer (polymerized at 30.8% in water) are dissolved in 59.25 g of water in the presence of 3.8 g of 10% sodium hydroxide solution by stirring in a mechanical stirrer at a temperature of 40° C.

7.88 g of paraffin wax sold by Sigma-Aldrich (Tf₁=53-57° C.) are mixed with 7.88 g of commercial sunflower oil and 47.25 g of terpineol (Sigma-Aldrich). The mixture is stirred and heated to a temperature of approximately 80° C.

This liquid ternary mixture (at a temperature of between Tf₁ and 80° C.) is introduced into the aqueous solution of HASE copolymer using a peristaltic pump.

Coacervation

6.44 g of a 4% H₃PO₄ solution are added to the aqueous solution of HASE copolymer to which the liquid ternary mixture has been added. A dispersion which is white in color, the D50% particle diameter of which is 2.73 μm, is obtained.

### Test 3-2: Preparation of a Dispersion of Microparticles Outside the Invention

Preparation of an Aqueous Solution

7.5 g of the HASE copolymer (polymerized at 30.8% in water) are dissolved in 59.25 g of water in the presence of 3.8 g of 10% sodium hydroxide solution by stirring in a mechanical stirrer at a temperature of 40° C.

15.75 g of paraffin wax sold by Sigma-Aldrich (Tf₁=53-57° C.) are mixed with 47.25 g of terpineol (Sigma-Aldrich). The mixture is stirred and heated to a temperature of approximately 80° C.

This liquid ternary mixture (at a temperature of between Tf₁ and 80° C.) is introduced into the aqueous solution of HASE copolymer using a peristaltic pump.

Coacervation

6.44 g of a 4% H₃PO₄ solution are added to the aqueous solution of HASE copolymer to which the liquid ternary mixture has been added. Lumps, the D50% diameter of which is 29.7 μm, are obtained.

1. Microparticles having a polymeric shell, comprising:
(a) at least one acrylic copolymer of HASE type comprising:
at least one anionic monomer having a polymerizable vinyl group and a carboxyl group;
at least one nonionic hydrophobic monomer having a polymerizable vinyl group; and
at least one alkoxylated associative macromonomer having a polymerizable vinyl group and a hydrophobic hydrocarbon chain;
(b) at least one solid/liquid phase change material having a phase transition temperature Tf₁ of greater than or equal to 20° C.,
(c) at least one solid/liquid phase change material having a phase transition temperature Tf₂ of less than or equal to 30° C., provided that Tf₂ is less than Tf₁; and
(d) optionally an active agent selected from the group consisting of fragrance molecules, flavorings, opacifying agents, hydrating agents, softening agents, refreshing agents, dyes, plasticizers, slimming agents, pharmaceutical active ingredients, inks, pigments, agrochemical active ingredients, herbicides, antiseptics, detergents, enzymes, antifoaming agents, bleaching agents, optical brighteners, biocides, UV stabilizers, antioxidants, corrosion inhibitors, fungicides and antibacterial agents.

2. The microparticles of claim 1, wherein said solid/liquid phase change material having a phase transition temperature Tf₁ of greater than or equal to 20° C. is chosen from waxes of natural origin, waxes of synthetic origin or their mixtures.

3. The microparticles as of claim 1, wherein said solid/liquid phase change material having a phase transition temperature Tf₂ of less than or equal to 30° C. is chosen from the group consisting of vegetable oils, fatty alcohols, fatty acids and their mixtures.

4. The microparticles of claim 1, said acrylic copolymer of HASE type comprises, based on the total weight of said copolymer:
(i) from 20% to 65% by weight of at least one anionic monomer having a polymerizable vinyl group and a carboxyl group;
(ii) from 35% to 75% by weight of at least one nonionic hydrophobic monomer having a polymerizable vinyl group; and
(iii) from 0.5% to 15% by weight of at least one alkoxylated associative macromonomer having a polymerizable vinyl group and having a hydrophobic hydrocarbon chain.

5. The microparticles of claim 4, wherein said at least one alkoxylated associative macromonomer (iii) of said acrylic copolymer of HASE type has a formula (I):
R-A-R′ (I)
wherein:
A represents a polymer chain consisting of:
m alkylene oxide units of formula —CH₂CHR₁O— with R₁ representing an alkyl group comprising from 1 to 4 carbons, and m varying from 0 to 150;
p alkylene oxide units of formula —CH₂CHR₂O— with R₂ representing an alkyl group comprising from 1 to 4 carbons, and p varying from 0 to 150; and
n ethylene oxide units with n varying from 0 to 150,
wherein m+n+p>4 and in which the alkylene oxide units of formula —CH₂CHR₁ O—, the alkylene oxide units of formula —CH₂CHR₂O— and the ethylene oxide units are in blocks, alternating or random,
R represents a radical containing a polymerizable unsaturated group belonging to the group of acrylic, methacrylic, maleic, itaconic or crotonic esters, and
R′ represents a straight or branched hydrocarbon chain comprising from 6 to 40 carbon atoms or a substituted or unsubstituted cycloalkyl or aryl group comprising from 6 to 100 carbon atoms.

6. The microparticles as claimed of claim 5, wherein said alkoxylated associative macromonomer (iii) of formula (I) is such that:
m and p respectively represent 0,
n varies from 15 to 150,
R represents a radical comprising a polymerizable unsaturated group belonging to the group of acrylic, methacrylic, maleic, itaconic or crotonic esters, and
R′ represents a straight hydrocarbon chain comprising from 8 to 22 carbon atoms or a branched alkyl chain comprising from 12 to 20 carbon atoms.

7. The microparticles as claimed claim 1, comprising, based on the total weight of the microparticles:
(a) from 1 to 20% by weight of said at least one acrylic copolymer of HASE type;
(b) from 4 to 95% by weight of at least one solid/liquid phase change material having a phase transition temperature Tf₁ of greater than or equal to 30° C.;
(c) from 4 to 95% by weight of at least one solid/liquid phase change material having a phase transition temperature Tf₂ of less than or equal to 30° C., provided that Tf₂ is less than Tf₁; and
(d) from 4 to 95% by weight of an active agent.

8. An aqueous dispersion, comprising microparticles of claim 1.

9. A process, for rendering textiles hydrophobic, comprising employing the microparticles of claim 1.

10. A process, comprising releasing an active agent encapsulated in the microparticles of claim 1, in response to a change in pH, a change in temperature and/or to frictions.
